(19) United States
(12) Patent Application Publication
(10) Pub. No.: US 2003/0120540 A1
(43) Pub. Date: Jun. 26, 2003

(54) Advertisement method used in automated service system

(76) Inventor: Hung-Chun Yang, Taipei City (TW)

Correspondence Address: BRUCE H. TROXELL, 5205 LEESBURG PIKE, SUITE 1404, FALLS CHURCH, VA, 22041, US

(21) Appl. No.: 10/025,856

(22) Filed: Dec. 26, 2001

(51) Int. Cl. G06F 17/60

(52) U.S. Cl. 705/14

(57) ABSTRACT

An advertisement campaign method has steps of entering the preset transaction process; wherein when a user is using the automated service system for transaction, the automated service system provides preset processes; data input; wherein data is input according to the preset processes; data processing and transmission; wherein the automated service system processes the chosen preset process or sends it to a information center for further processing; linking and displaying advertisement; wherein the automated service system links an advertisement databank so that the system is able to display the advertisement with a screen; and accomplishing data processing and transfer; wherein after the data is processed, the advertisement display is selectively stopped and then the system returns the screen back to the transaction picture for another transaction or predetermined processes.

### BACKGROUND OF THE INVENTION

1. Field of the Invention

The present invention relates to an advertisement campaign method, and more particularly to an advertisement campaign method for an automated service system. The method is able to exhibit advertisement according to a preset program so that a series of advertisements are sequentially presented or a sole advertisement is repeatedly played.

2. Prior Art Description

Nowadays, automated service system is provided almost everywhere. With the convenience of the automated service system, users are able to have access to valuable information. The following description is based on one of the automated service system, the ATM (automated teller machine), for reference. With reference to FIG. 3, the conventional ATM system provides the user the following processes for transaction:

Entering the preset transaction process 91;

When the user approaches the ATM system and inserts the ATM card, the user initiates a series of preset transactions.

Inputting data 92;

After the ATM card is inserted into the system, the user chooses from the preset programs or the user is able to choose to input data to initiate programs such as language choice, cash withdraw, transfer funds, change code, balance inquiry . . .

Data processing 93;

After the program is chosen and related data is inputted according to the instruction shown on the ATM screen, the data is being processed. While the data is processed, the user waits in front of the ATM. Meantime, the ATM screen shows “Data in processing” or the logo or other services of the bank. The data processing step comprises code verification, whether the card is declared lost, stop payment or the account is being frozen, whether the balance is enough for deduction or the cash withdraw or funds transfer exceeds daily allowance.

Post process 94;

After the previous chosen program is finished, the ATM switches back to the original transaction picture for further transaction program choosing.

As described in step 91, most advertisement is played while there is no user using the ATM. Further, for privacy sake and lack of time looking around, most pedestrians do not pay too much attention to the advertisement on the ATM screen. Accordingly, there is almost no effect to the advertisement provider. Because most advertisements are compiled with the ATM system program, the maintenance technique to the software or hardware is held by the ATM provider. Therefore, if the bank wants to change its logo or any information shown on the screen, the bank needs to ask for technique support from the ATM provider.

To overcome the shortcomings, the present invention intends to provide an improved advertisement campaign method for automatic service system to mitigate or obviate the aforementioned problems.

### SUMMARY OF THE INVENTION

The primary objective of the invention is to provide an advertisement campaign method which is able to capture the “loophole” in transaction to display advertisement so as to achieve the purpose of advertisement.

Another objective of the invention is to provide a communication mode so that the bank needs not the ATM provider to provide services concerning the change of advertisement content.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of the present invention;

FIG. 2 is a schematic view showing the preferred embodiment of the invention; and

FIG. 3 is a flow chart of a conventional ATM.

### DETAILED DESCRIPTION OF PREFERRED EMBODIMENT

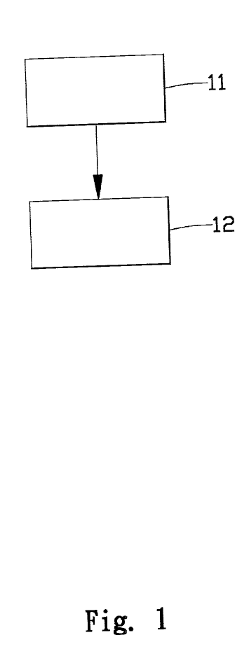

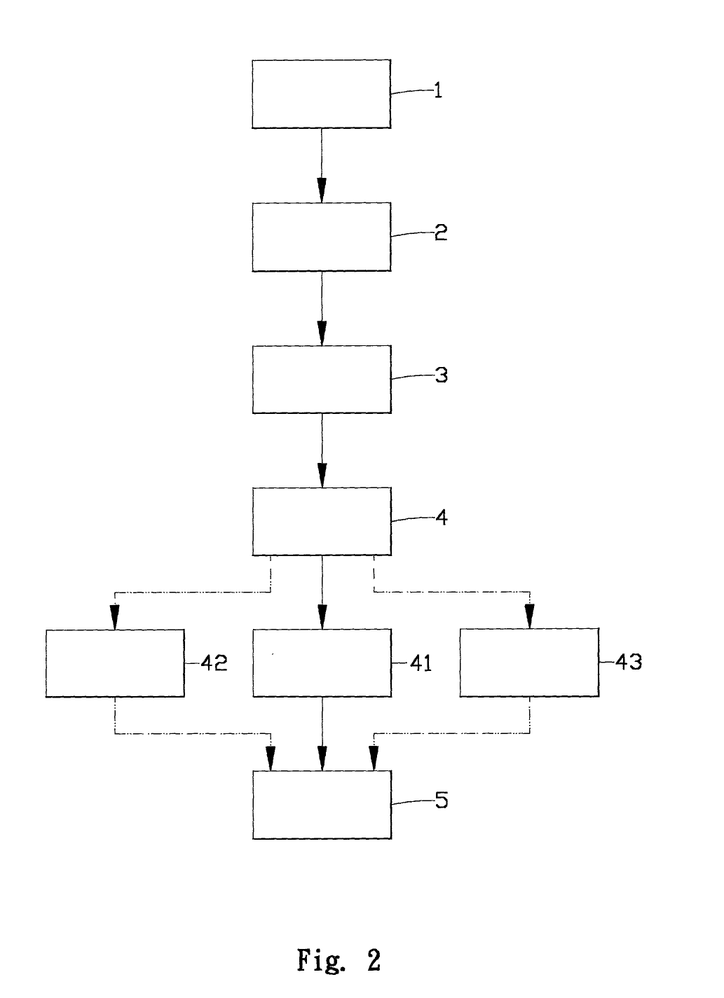

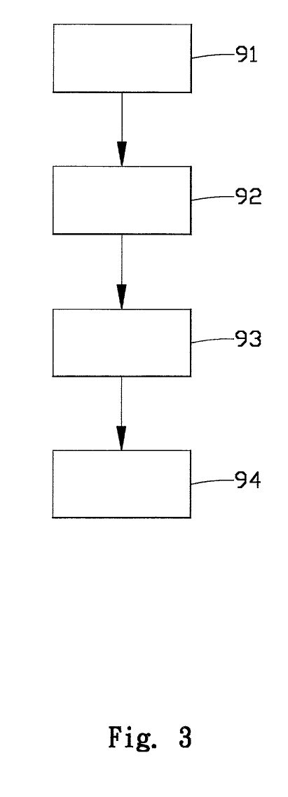

With reference to FIGS. 1 to 3, the preferred embodiment of the invention is applied to an automatic teller machine (ATM) and thus the installation of the advertisement campaign method of the present invention includes the following steps:

Step 1; categorization 11,

The clients are categorized into different categories according to preset conditions, such as:

(1) ID number;

(2) Group characteristics, i.e., male or female, age groups, occupations, marriage status, etc.

(3) Clients of this agency or of other related agency; and

(4) Others as required.

Step 2, setting communication box 12 which contains pictures, audio information etc., for retrieval or access. The information in the communication box 12 may be played according to the result of the categorization 11 in step 1. However, in another embodiment of the invention, step 1 may be changed to step 2 and step 2 may be changed to step 1.

The communication method of the present invention comprises:

Step 1, providing preset transaction process;

When a user is using the ATM automatic service system for transaction, the ATM provides preset processes such as “insert ATM card”, “password entering”.

Step 2, data input;

The user chooses the services or inputs further information based on the preset processes, which includes language change, cash withdraw, transfer funds, change code, balance inquiry . . .

Step 3, data processing and transmission;

The automatic service system processes the user's data or sends it to the information center.

Step 4, information transmission;

The automatic service system first communicates the communication box to see if there is any information in the communication box. If there is an information the information is sent to the user. It is to be noted that the method of this information transmission should at least include:

Step 41, the information is retrieved directly from the communication box and sent to the automatic service system which in turn sends the information to the user. Furthermore, the automatic service system is able to print all the information for the receipt of the user.

Step 42, confirmation of information in the communication box. If an information exists in the communication box, the information is sent back to the automatic service system and displayed on the screen.

Step 43, confirmation of information in the communication box. If a further information exists in the communication box, the information together with the result of the processes information will be sent back to the automatic service system. If there is no information in the communication box, only the processed information result is sent back.

Step 5, completion of information processing and post work. After all the information is processed, the screen shows choices to the user for post work, such as retrieve card, cash or other services.

It is noted that most users focus their attention on the screen during the entire transaction period, which allows the advertisement campaign to have its ultimate effect to the user. Furthermore, during the transaction, there will be no commercials or any disruption like the TV program. Accordingly, the advertisement effect on the users is enormous.

Accordingly, the present invention is suitable for the following marketing strategy:

Lobbing the client to purchase a certain insurance policy, trust fund and other merchandise.

Wishing happy birthday to the user when the user is using the ATM.

Notifying important information to the user. Important information is able to send to the user by this method other than the conventional mail, phone call. Therefore, the agency is able to accomplish the purpose of remind the user of a certain important message while capture the opportunity when the user is using the ATM.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An advertisement campaign method for an automated service system comprising the following acts:
(A) entering the preset transaction process; wherein when a user is using the automated service system for transaction, the automated service system provides preset processes;
(B) data input; wherein data is input according to the preset processes;
(C) data processing and transmission; wherein the automated service system processes the chosen preset process or sends it to a information center for further processing;
(D) information transmission, wherein the automated service system links an advertisement databank at step (C) so that the system is able to display the advertisement through a screen to the user and an information received in a communication box is retrieved and sent to the user;
(E) accomplishing data processing for post work; wherein after the data is processed, the advertisement display is selectively stopped and then the system returns the screen back to the transaction picture for post work such as retrieval of card or another transaction or any other predetermined processes.

2. The method as claimed in claim 1, wherein the automatic service system is an automatic teller machine.

3. The method as claimed in claim 1, wherein the system returns the screen back to the transaction picture after advertisement display is finished.

4. The method as claimed in claim 1, wherein a conformation step is processed to see if there is an information in the communication box before step (C).

5. The method as claimed in claim 4, wherein a confirmation step is processed to see if there is an information in the communication box before step (D).

6. The method as claimed in claim 1, wherein a confirmation step is processed to see if there is an information in the communication box before step (D).

7. An advertisement campaign method for an automated service system comprising the following acts:
categorization;
wherein the clients are categorized into different categories according to preset conditions,
setting a communication box which contains pictures, audio information etc., for retrieval or access
entering the preset transaction process; wherein when a user is using the automated service system for transaction, the automated service system provides preset processes;
data input; wherein data is input according to the preset processes;
data processing and transmission; wherein the automated service system processes the chosen preset process or sends it to a information center for further processing;
information transmission, wherein the automated service system links an advertisement databank at the data processing and transmission step so that the system is able to display the advertisement through a screen to the user and an information received in the communication box is retrieved and sent to the user;
accomplishing data processing for post work; wherein after the data is processed, the advertisement display is selectively stopped and then the system returns the screen back to the transaction picture for post work such as retrieval of card or another transaction or any other predetermined processes.

8. The method as claimed in claim 7, wherein the automatic service system is an automatic teller machine.

9. The method as claimed in claim 7, wherein the system returns the screen back to the transaction picture after advertisement display is finished.

10. The method as claimed in claim 7, wherein a conformation step is processed to see if there is an information in the communication box before the data processing and transmission step.

11. The method as claimed in claim 7, wherein a confirmation step is processed to see if there is an information in the communication box before the information transmission step.

12. The method as claimed in claim 10, wherein a confirmation step is processed to see if there is an information in the communication box before information transmission step.
